(19) United States
(12) Patent Application Publication
(10) Pub. No.: US 2002/0092012 A1
(43) Pub. Date: Jul. 11, 2002

(54) Smart-caching system and method

(76) Inventor: Alexandre K. Shah, San Deigo, CA (US)

Correspondence Address: FOLEY, HOAG & ELIOT, LLP, PATENT GROUP, ONE POST OFFICE SQUARE, BOSTON, MA, 02109, US

(21) Appl. No.: 09/757,367

(22) Filed: Jan. 9, 2001

(51) Int. Cl. G06F 9/455

(52) U.S. Cl. 717/170

(57) ABSTRACT

Methods and systems to distribute cached information for efficient processing without overloading system resources. In an embodiment, VGENs can be implemented as software engines that can reside on a web server or another server that responds to requests for information in a networked environment. A hash table can identify whether a VGEN exists with cached information to process the request. If an available VGEN engine includes the cached information, the available VGEN is assigned to process the request; otherwise, another available VGEN can be selected to process the request, wherein the VGEN is augmented to include the cached information and the hash table is updated to reflect the VGEN statistics. VGENs can maintain persistent connections to databases, file systems, session manager daemons, real-time data sources, etc., to facilitate the processing of requests.

### BACKGROUND OF THE INVENTION

(1) Field of the Invention

The present invention relates generally to expedited data retrieval and processing, and more particularly to efficient caching techniques.

(2) Description of the Prior Art

A cache is commonly known as a memory or another type of storage device, utilized to store data on a temporary basis. The degree of the term “temporary” can vary widely depending upon the application and configuration of a system utilizing the cache. For example, for an internet user utilizing a personal computer (PC) to browse the internet, web pages requested by the user are retrieved from an original server on the internet, and thereafter often stored in the user's internet browser's cache directory on the user PC's hard disk. By utilizing a cache to store requested internet web pages, subsequent requests for the same web page can be processed by retrieving the web page from the cache rather than the original server, hence relieving the internet of additional traffic and providing a more rapid response to the user.

The term “cache memory” often refers to random access memory (RAM) that a computer microprocessor can access more quickly than typical RAM. Alternately, “disk cache” is intended to improve the speed for writing and reading to/from a storage device such as a hard drive, and disk cache can be part of the hard disk, or a specified portion of RAM. In some systems where internet accessibility, connectivity, and content requests are prevalent, caching can be implemented across multiple servers wherein the server caches are periodically refreshed.

Caches can be implemented at the user level to serve a specific user, or caches can be designed to serve larger combinations of user. For example, macro caches can be designated on systems serving international, national, regional, or organizational users to preserve, periodically update, and make available for distribution, information anticipated to be highly requested by users of the system. Similarly, local server caches can be designed for corporate LANs, access provider servers, etc., for example, to similarly cache information determined to be more popular at a more localized level.

As the popularity of the internet increases, the need for more efficient caching is desired to decrease processing times and bandwidth demands on the internet.

There is currently not an efficient method of caching information that can be easily adapted for the increasing demands provided by systems or networks such as the internet.

What is needed is a system and method for efficient caching.

### SUMMARY OF THE INVENTION

This disclosure reveals methods and systems for responding to a request for information using software processes or threads, otherwise referred to herein as VGENs. In an embodiment, the request for information can be a HTTP request as received through a network such as the internet, however the invention herein is not limited to such an embodiment, and requests can be processed through other networks or non-networked environments. Similarly, requests other than HTTP requests can be processed.

In an embodiment wherein the request includes a Uniform Resource Location (URL), the URL can be used to generate a key that provides an index to a hash table. The hash table establishes relationships between requests or corresponding keys and any software threads that have previously processed those requests or corresponding keys.

In an embodiment, the software threads, or VGENS, are capable of being modified by incorporating application code into the software thread. Similarly, application code within a software thread can be updated to a latest version to provide uninterrupted processing of requests.

In an embodiment wherein a hash table is used to relate a key from a URL to a software thread, if none of the software threads have processed a request according to the key, a software thread is used that corresponds to the non-processing software thread that has been in a non-processing state for the longest period of time when compared to other non-processing threads. Alternately, if one or multiple software threads are identified through the hash table as having processed a request according to the key, the non-processing identified thread that has been in a non-processing state for the longest time is selected.

When a VGEN or software thread is selected to process a particular request for a first time, the software thread can retrieve application code to process the request, byte-compile the code, and incorporate the code into the software thread. If persistent connections to databases, real-time data sources, file systems, session manager daemons, etc., facilitate processing the request, the software thread can establish and maintain such persistent connections for future processing requests. The software thread can also retrieve data from these persistent connections, optionally process it to a more rapidly accessible form and store it into the thread's local memory. This is sometimes referred to as localized caching. Alternately, during subsequent requests for processing, a VGEN can compare the VGEN's byte-compiled version of code for a given request to an off-line repository for storing application code, to determine the latest version of application code. If the off-line code is a new version, the VGEN can retrieve, byte-compile, and incorporate the new code accordingly. The off-line repository can be any memory device or device that includes a memory, is accessible to the software thread, and capable of storing application code.

The VGENs can reside on a server or other processor that receives a request, or the VGENs can reside on other processor-based machines or servers that are not responsible for receiving the request. A request received by one server can thus be propagated to one or multiple other servers for processing by VGENs.

Other objects and advantages of the invention will become obvious hereinafter in the specification and drawings.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings, wherein like reference numerals refer to like parts and wherein:

FIG. 1 is a block diagram of a system practicing the basic principles of the invention for implementing VGEN engines in a web server embodiment;

FIG. 2 shows a block diagram illustrating the updating of application code in a VGEN;

FIG. 3 demonstrates two embodiments of VGEN engines in accordance with a system according to FIG. 1;

FIG. 4 illustrates a system in accordance with FIGS. 1 and 3, wherein a request from a web server is processed by a VGEN engine;

FIG. 5 is shows a hash table for utilization by a system according to FIG. 4, wherein VGEN engines can be identified through URL keys;

FIG. 6 provides a logic block diagram demonstrating the selection of a VGEN engine for a system in accordance with FIGS. 1, 3, and 4.

### DESCRIPTION OF ILLUSTRATED EMBODIMENTS

To provide an overall understanding of the invention, certain illustrative embodiments will now be described; however, it will be understood by one of ordinary skill in the art that the systems and methods described herein can be adapted and modified to provide systems and methods for other suitable applications and that other additions and modifications can be made to the invention without departing from the scope hereof.

For the purposes of the disclosure herein, a “server” can be understood to include a processor, a memory (e.g. RAM), a bus to couple the processor and the memory, a mass storage device (e.g. a magnetic or optical disk) coupled to the processor and the memory through an I/O controller, and a network interface coupled to the processor and the memory. The servers may further include one or more mass storage devices such as a disk farm or a redundant array of independent disks (“RAID”) system for additional storage and data integrity. Read-only devices, such as compact disk drives and digital versatile disk drives, may also be connected to the servers. Servers can be understood to be, for example, personal computers (PCs), SUN workstations, handheld, palm, laptop, or other microprocessor controlled devices for performing the operations and functions as described herein and attributed to servers. Servers can be connected via networks for more efficient processing of client traffic. Servers in stand-alone or network configurations can operate together or independently for different functions, wherein a server can be designated a database server, an application server, a web server, etc. As used herein, the term “server” is intended to refer to any of the above-described servers that further includes instructions for causing the server processor to perform the functions designated and attributed to the servers herein.

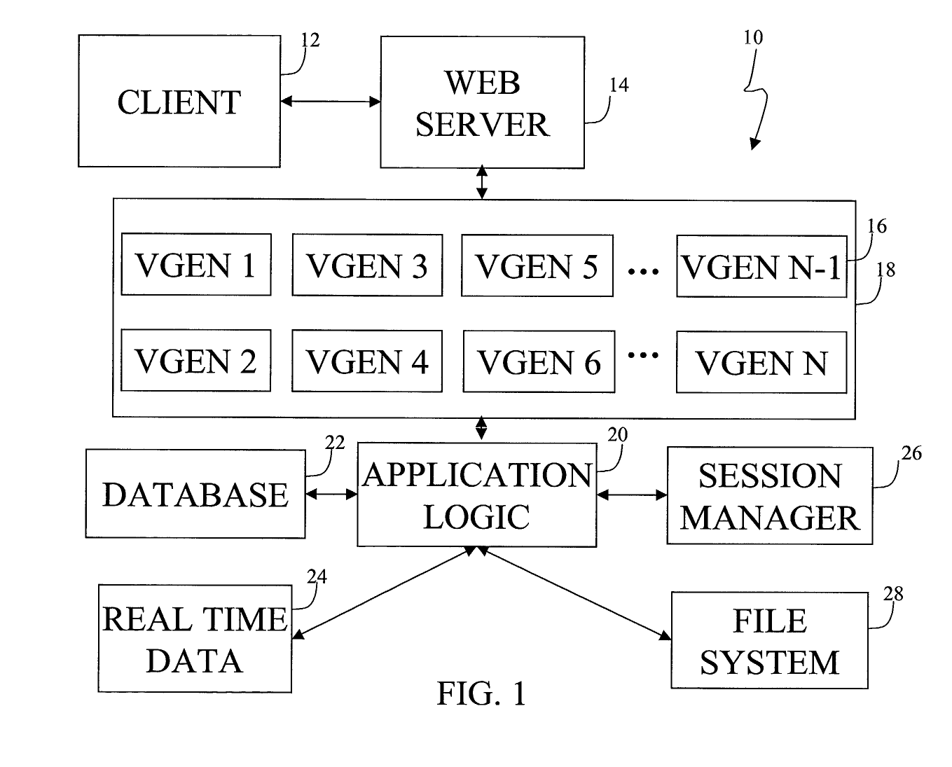

Referring now to FIG. 1, there is a block diagram 10 of a system practicing the basic principles of the invention for implementing VGEN engines in a web server embodiment. Although the illustrated embodiments of the methods and systems can be interpreted with respect to a networked environment such as the internet, those with ordinary skill in the art will recognize that the methods and systems are not limited to an internet application and can be applied to any method or system implementing caching techniques. In the exemplary internet embodiment of FIG. 1, any one of well-known internet browsers executing on a client 12, can execute a command to retrieve requested information, including for example, a web document, web page, content information, etc., wherein the information is retrieved from a specified internet address that corresponds to, in the illustrated embodiment, a web server 14. In an embodiment, the illustrated client 12 can be a server as defined previously herein. As is well-known in the art, the requested information can be displayed or otherwise presented to a user of the client 12 via a viewing device such as a display, screen, etc., that is otherwise integrated with the client 12. In the internet embodiment, user requests for information can be executed via the browser on the client 12 wherein the browser provides an interface for the user to designate a Uniform Resource Location (URL) and cause the browser to execute an Hyper-Text Transfer Protocol (HTTP) request to the web server 14, wherein in the illustrated embodiment, the illustrated web server 14 corresponds to the URL designated by the user. The web server 14 responds to the http request by transmitting the requested information to the client 12. Those with ordinary skill in the art will recognize that the retrieved information can be in the form of an HTTP object that includes plain text (ASCII) conforming to the HyperText Markup Language (“HTML”), Dynamic HyperText Markup Language (“DHTML”), Extensible Markup Language (“XML”), the Extensible Hypertext Markup Language (“XHML”), Standard Generalized Markup Language (“SGML”), etc. Additionally, the retrieved information can include hyperlinks to other Web documents, and the web server 14 can execute programs associated with the retrieved information using programming languages such as Perl, C, C++, or Java. The web server 14 can also utilize scripting languages such as ColdFusion from Allaire, Inc., or PHP, to perform “back-end” functions such as order processing, database management, and content searching. Retrieved information in the form of a web document may also include references to small client-side applications, or applets, that are transferred from the web server 14 to the client 12 with the web document and executed locally by the client 12, wherein Java is one popular exemplary applet programming language. The text within a web document may further include non-displayed scripts that are executed by an appropriately enabled browser using a scripting language such as JavaScript or Visual Basic Script. Browsers can further be enhanced with a variety of helper applications to interpret various media including still image formats such as JPEG and GIF, document formats such as PS and PDF, motion picture formats such as AVI and MPEG, and sound formats such as MP3 and MIDI. These media formats, with an increasing variety of proprietary media formats, can enrich a user's interactive and audio-visual experience as a web document is presented through the browser at the client 12.

Although the FIG. 1 system illustrates a client 12 and server 14 configuration, those with ordinary skill in the art will recognize that the methods and systems herein can be applied to a configuration wherein the illustrated client 12 can also be a server such as the web server 14 illustrated in FIG. 1. For example, application logic executed by a first server (e.g., depicted as the client 12) having the same attributes and functionality of the illustrated web server 14, can issue a HTTP request to a second web server (e.g., depicted as the web server 14), wherein the application logic can be executed on the second server to produce, for example, XML results. In this example embodiment, the XML results from the second server can be transferred to the first server and thereafter to the initial requesting entity. In other embodiments, multiple numbers of servers such as the web server 14 of FIG. 1, can make requests of each other, wherein the subsequent server's results can be transferred to a requesting server. In different embodiments, the requesting and executing servers can be configured the same or differently while remaining in the scope of the invention.

Referring again to the methods and systems of FIG. 1, the illustrated web server 14 processes the request from the client 12 using at least one VGEN Engine 16, otherwise referred to as a VGEN, wherein in the FIG. 1 embodiment, there are N VGENs 18, where N is a positive integer. The illustrated VGENs 18 are software processes or threads that can be executed separately from the web server functionality as such web server functionality is previously described herein, although a VGEN can reside on the web server 14 and be processed by the web server processor. Alternately, a VGEN 16 can reside on a server that is distinct from the web server 14 but can be in communication with the web server 14.

In the illustrated embodiments, VGEN processes 18 execute continuously and can execute scripts, run applications, connect to databases, etc. In an embodiment, a standard VGEN 16 at system initialization includes applications and basic instructions for executing tasks such as loading data (applications, database data, XML pages, CGI scripts, etc.) into the VGEN 16, parsing data, processing applications, byte-compiling data, establishing and maintaining persistent connections, etc., although such base functionality is merely provided for illustration and not limitation, and those with ordinary skill n the art will recognize that other embodiments of VGENs 18 can include additional functionality or less functionality while remaining in the scope of the invention.

The illustrated VGENs 18 can retrieve, cache, and distribute dynamic and other content, and generate requested web document (“page”) information and forms. Those with ordinary skill in the art will recognize that the illustrated VGENs 18 can be implemented in hardware or software, and in either embodiment, VGENs can access cache memory, wherein such cache may be resident on the web server 14 or on another server, computer, etc. In one embodiment, every VGEN 18 maintains a connection to a dedicated cache area to increase system robustness, however in alternate embodiments, VGENs 18 can share cache areas or segments. For example, a single cache area can be partitioned or otherwise divided for the number of VGENs. In an embodiment wherein VGENs process similar or identical information, multiple VGENs can access a common cache area. In yet another embodiment, a common cache area can be replaced with the ability of each VGEN to access the cache of other VGENs.

As indicated by FIG. 1, the illustrated VGENs 18 can also access Application Logic 20 that is typically located on memory that can reside on the web server 14, another networked machine, or otherwise accessible memory; and, the application logic 20 can include, for example, CGI Pages, XML Pages, Server Pages, etc. As mentioned previously, a basic VGEN 16 includes logic for byte-compiling applications, and therefore when an illustrated VGEN 16 retrieves application logic 20 from memory, the illustrated VGEN 16 can byte-compile and cache the application logic 20 into the VGEN 16 logic for subsequent, rapid execution of the application in responding to subsequent requests for the application 20.

As indicated in illustrated system of FIG. 1, the application logic 20 can be facilitated through a persistent connection with a database 22, real-time data 24, a session manager daemon 26, a file system 28, etc., although those with ordinary skill in the art will recognize that persistent connections can be maintained with other devices or objects without departing from the scope of the invention. The illustrated real-time data 22 can be provided through an input/output port or other source, while the illustrated file system 28 can represent the web server's file system, or another file system.

When an illustrated VGEN 16 byte-compiles application code 20 and incorporates the code into the VGEN 16, the VGEN 16 can maintain the persistent connections as deemed necessary by the application 20. As requests are obtained by the web server 14 and distributed to VGENs 18, the respective VGENs 18 can aggregate byte-compiled application code 20 and associated persistent connections. By distributing the requests across the various VGENs 18, respective VGENs 18 can be requested to execute subsequent requests for respective application code, thereby providing an increased cache system without the disadvantages of continually compiling and caching application logic 20 and maintaining persistent connections to every data source from every VGEN.

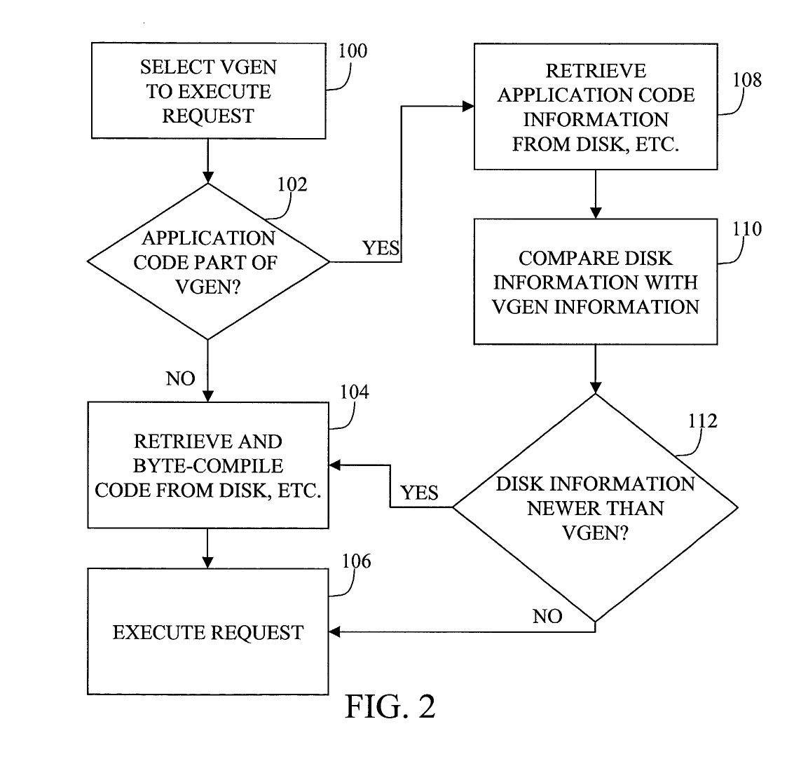

The FIG. 1 system also provides a mechanism to provide updates to application code 20 without disrupting the web server 14 in its ability to handle requests from the illustrated client 12. As indicated previously, the illustrated VGENs 18 include basic functionality to retrieve application code 20; however, this logic also includes the ability to verify application code that is presently byte-compiled within the selected VGEN 18. FIG. 2 shows a block diagram indicating a logic flow for the illustrated VGENs 18 of FIG. 1 that allows for the uninterrupted update of application code 20.

As indicated in FIG. 2, when a request is received by the web server 14 of FIG. 1, an illustrated VGEN 18 of FIG. 1 is selected to process the request 100 as shall be described herein. The selected VGEN can verify whether the application code 20 to execute the request resides within the selected VGEN 102, and if the selected VGEN does not include the application code 20, the application code 20 is retrieved from memory, disk, etc. 104, byte-compiled, incorporated into the VGEN, and utilized to execute the request 106. Returning to 102, alternately, if the selected VGEN determines that the selected VGEN does include the application code 20 to process the request, the selected VGEN retrieves information about the latest version of the application code 20 from memory, disk, etc., 108 and compares the newly retrieved application code information with the application code information from the selected VGEN 110. If the newly retrieved application code information indicates that the memory, disk, etc., includes an updated or more recent version of the application code as compared to the application code in the VGEN 112, the newer application code 20 can be retrieved from memory, disk, etc., 104 byte-compiled, incorporated into the selected VGEN to replace the previous version of the application code, and utilized to execute the request 106. Returning to 112, if the application code in memory, on disk, etc., is not newer than the application code that is part of the selected VGEN, the application code is not retrieved from memory, disk, etc., the selected VGEN does not change, and the existing selected VGEN is utilized to process the request 106.

One with ordinary skill in the art will recognize that certain requests from clients occur with greater frequency than other requests; therefore, for the illustrated systems and methods, multiple VGENs 18 may include the same or similar application logic 20 and associated persistent connections to facilitate multiple and/or simultaneous requests for the same or similar information. Additionally, although the illustrated systems and methods retrieve and replace newer versions of application code 20 to update the respective VGEN 18, in other embodiments, multiple versions of application code can be incorporated into a VGEN 18.

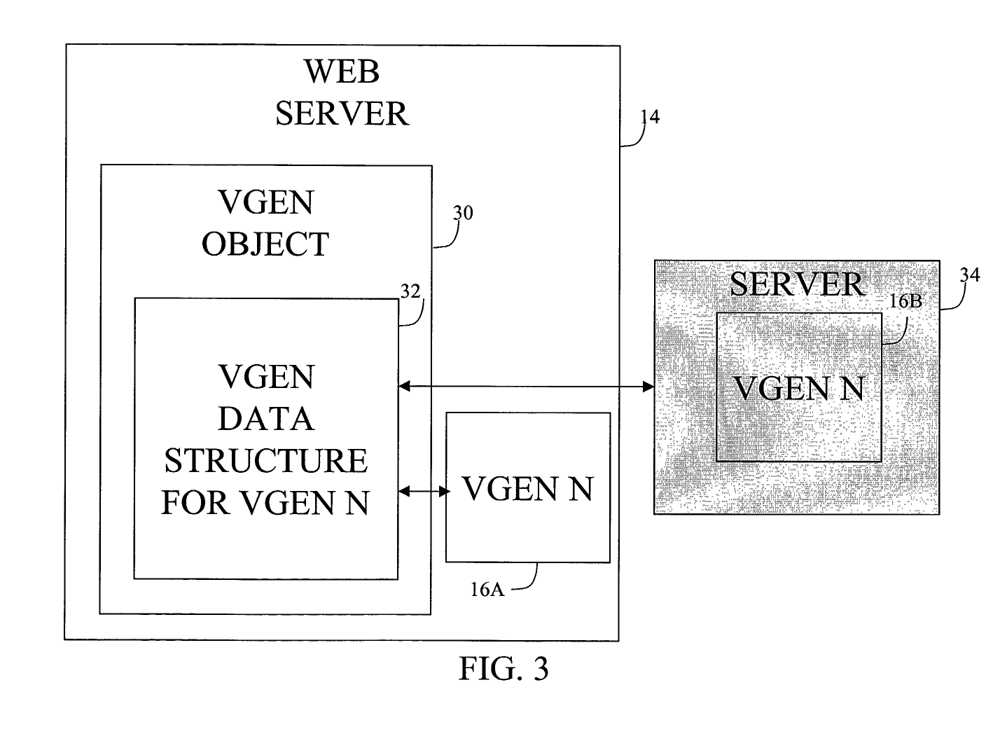

Referring to FIG. 3, there is a diagram illustrating two embodiments of VGEN implementations in accordance with a system according to FIG. 1. As illustrated in FIG. 3, the web server 14 can include a VGEN object 30 that thereafter includes a VGEN data structure 32 that maintains statistics for a VGEN 16. In an embodiment, the VGEN object 30 can be a thread-safe C++ module that interfaces with the web server's 14 high performance extension interface. In the illustrated system, there is a VGEN data structure 32 for every VGEN 16, but those with ordinary skill in the art will recognize that other implementations and/or structures can accomplish the same result of maintaining data related to a VGEN 16, without departing from the scope of the invention. In the illustrated system, the VGEN data structure 32 can include information based on the current processing status of a VGEN 16, the length of time a VGEN 16 has been processing data, security permissions for a VGEN 16, application code or data in a VGEN, persistent connection information, etc. In one embodiment illustrated in FIG. 3, the VGEN data structure 32 maintains data on a VGEN 16a that resides within the web server 14.

In another embodiment illustrated in FIG. 3, the VGEN data structure 32 can maintain information on a VGEN 16b that resides on a server 34 that is distinct from the web server 14. The invention herein is not limited to either of the two embodiments indicated in FIG. 3, and can include combinations of the two illustrated embodiments wherein some VGENs 16a reside on the web server 14, while other VGENs 16b reside on any of various other servers 34. Similarly, in the illustrated embodiment, the VGEN object 30 and VGEN data structure 32 can reside at locations other than the web server 14. One with ordinary skill in the art will therefore recognize in referring to FIGS. 1 and 3, that the system of FIG. 1 that displays the web server 14, VGENs 18, application code 20, databases 22, etc., as distinct elements, such display is merely for illustration purposes, and the elements therein can be combined and incorporated as part of the web server 14, or can be distributed across multiple servers or other platforms, without departing from the scope of the invention.

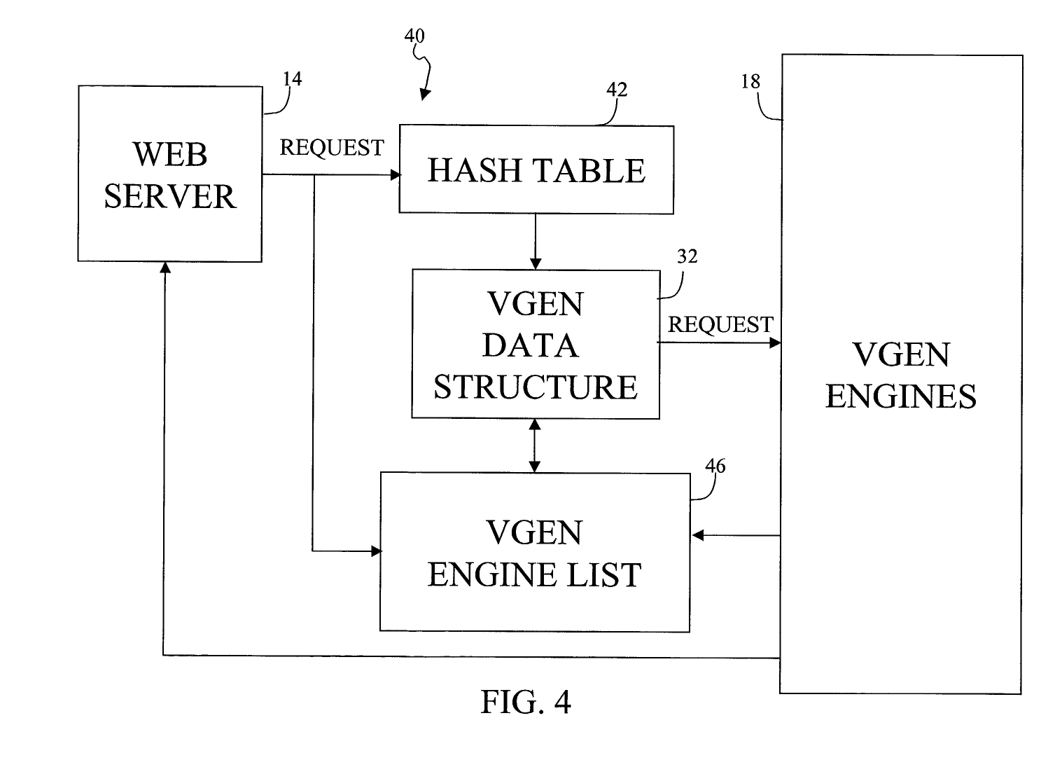

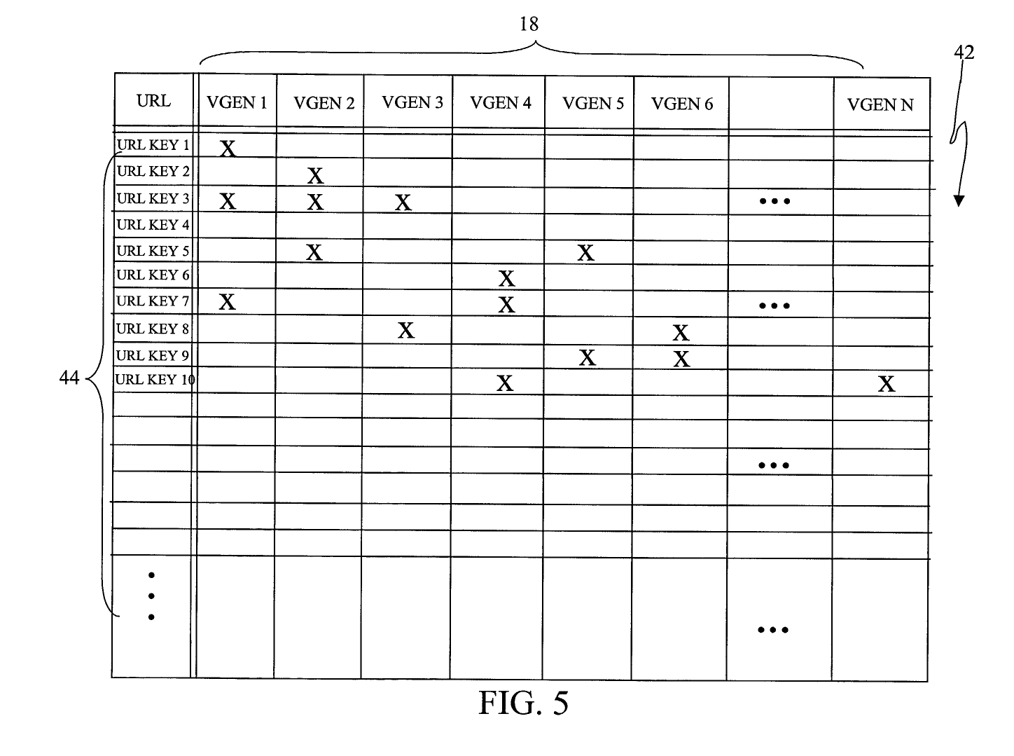

Referring now to FIG. 4, there is shown a basic methodology 40 indicating the processing of a request received by the web server 14 of FIGS. 1 and 3. As FIG. 4 indicates, in the illustrated systems, the request is transferred to a hash table 42 and VGEN engine list 46 that utilize information from the request. Referring now to FIG. 5, an exemplary hash table 42 is presented to indicate the methodology by which the web server 14 of FIGS. 1 and 3 determines which of the various VGENs should process a request.

As indicated previously with respect to FIG. 1, the web server 14 can receive a HTTP request from the client 12 that includes a URL. The illustrated systems and methods can utilize the URL information in the HTTP request to generate a key 44 for the hash table 42 illustrated in FIG. 4. For example, a URL parsed from the HTTP request can have the general format of: http://host:port/path;params?query. In an embodiment, a hash table key 44 can be generated using, for example, the “path” and “params” values only, although such example is provided merely for illustration and not limitation. Once generated, the key 44 can be related to one or more VGENs 18 associated with the key 44. Although FIG. 4 illustrates the relationship between the key 44 and VGENs 18 in tabular or matrix format, those with ordinary skill in the art will recognize that such relationships between keys 44 and VGENs 18 can be formulated using, for example, queues, linked lists, or any other well-known data structure for formulating relationships or otherwise associating data elements, wherein such mechanisms can be utilized in cooperation with, or to the exclusion of, a hashing algorithm.

In the illustrated embodiment, once the methods and systems determine the VGEN(s) 18 associated with the key 44 computed from the web server's request, the associated VGENs 18 are polled to determine an associated VGEN 18 available to process the request.

Referring back to FIG. 4, VGEN availability can be determined using information from the VGEN data structures 32 related to the associated VGENs 18. Similarly, the VGEN data structure 32 information can be provided in part from a VGEN Engine List 46 that monitors the activities of all VGENs 18 and maintains a list of available (i.e., currently non-processing) VGENs 18. In an embodiment, the Engine List 46 is a doubly linked-list of available VGENs, although such embodiment is provided for illustration and not limitation.

In the illustrated system of FIG. 5, the VGENs associated with the URL key and identified by the hash table 42, are polled to determine an available VGEN 18. In the illustrated systems, the first available, associated VGEN 18 is selected to process the request, and the processing result is thereafter provided to the web server 14 for response to the client 12 as indicated in FIG. 1.

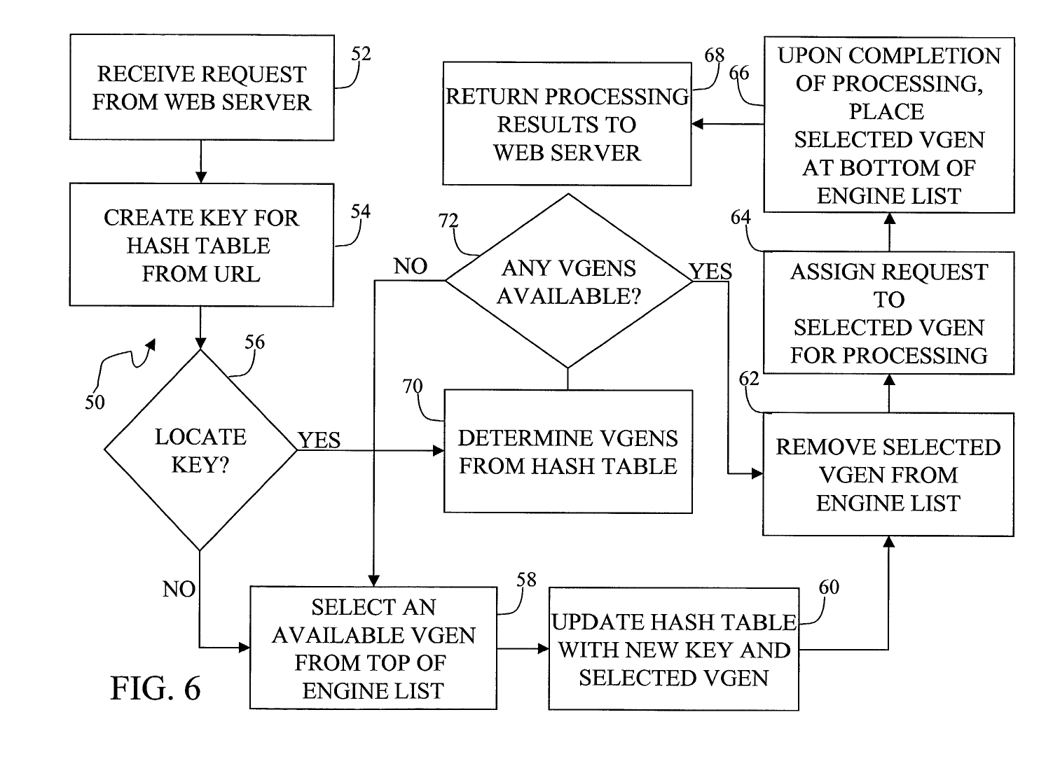

Referring now to FIG. 6, there is a block diagram 50 of the methodology to select VGENS 18 in the illustrated systems, for processing a request and distributing application code and cached information amongst the various available VGENS 18 to increase processing efficiency. As indicated in FIG. 6, for the illustrated systems and methods, a request is received from the web server 52, and from the request URL information, a hash table key is created 54. If the key does not exist in the hash table 56, a VGEN is selected from the top of the VGEN engine list 58. The hash table is thereafter modified to include the new key and selected VGEN 60, whereupon the selected VGEN is removed from the engine list 62, and the request is assigned to the selected VGEN for processing 64. Once the selected VGEN processes the request, the selected VGEN is returned to the bottom of the engine list 66 and the processing results are transferred to the web server 68. By assigning VGENs to new keys, extracting from the top of the VGEN engine list, and returning the assigned VGENs to the bottom of the VGEN engine list, load balancing is achieved between the various VGENS.

Referring again to FIG. 6, if the illustrated methods and systems determine that the key is located in the hash table 56, the list of VGENs (or single VGEN) associated with the key are determined 70, wherein the associated VGENs are polled to determine the an available, associated VGEN 72. In one embodiment, any such available associated VGENs can be ordered by time of last use or idle time, or some other designated criteria. If all associated VGENs are unavailable, a new VGEN is associated with the key by extracting an available VGEN from the top of the engine list 58. The illustrated system processing thereafter continues by updating the hash table 60, removing the selected VGEN from the engine list 62, assigning the request to the selected VGEN 64, waiting for completion of processing, and upon completion of processing, placing the selected VGEN at the bottom of the engine list 66 and returning the processing results to the web server 68.

Alternately, if one of the associated VGENs is available as determined by either the engine list and/or the VGEN data structures, the first such available VGEN is determined to be the “selected” VGEN and is accordingly removed from the engine list 62, the request is assigned to the selected VGEN 64, and upon completion of processing, the selected VGEN is returned to the bottom of the engine list 66 and the processing results are returned to the web server 68. Those with ordinary skill in the art will recognize that several of the processes as illustrated in FIG. 6, can be combined or otherwise interchanged without departing from the scope of the invention. For example, the processing results can be returned to the web server 68 while, before, or subsequent to, the VGEN being placed at the bottom of the engine list 66. Those with ordinary skill in the art will also recognize that the diagram of FIG. 6 did not include updates between the engine list and VGEN data structure such relationship was previously defined in FIGS. 3 and 4, and thus the availability of VGENs as shown in FIG. 6 can be derived from a VGEN data structure of FIGS. 3 and 4 via the engine list that communicates with the VGEN data structures, or in alternate embodiments, VGEN availability can be obtained directly from the engine list. Additionally, the logic flow of FIG. 6 is designed to accompany an embodiment of the invention as indicated in FIG. 1, and therefore the illustrative logic of FIG. 6 can be altered for alternate embodiments of the invention.

As the methods and systems of FIGS. 1-6 illustrate, the number of VGENs can be established (i.e., expanded or reduced) to facilitate the processing of requests according to system requirements. For example, if requests are being received wherein the Engine List 46 of FIG. 4 cannot accommodate the request, more VGENs can be added to ensure a list of available VGENs for all requests. As indicated previously, in many embodiments, there can be a likelihood that several VGENs can have the same information to process more popular requests. In some embodiments, each VGEN has a dedicated cache or section thereof, while in other embodiments, VGENs that can process similar requests can share cached information.

One of several advantages of the present invention over the prior art is that distributed caching of information can be accomplished for efficient processing of information to prevent an overloading of system resources that would otherwise occur without such distribution.

What has thus been described are methods and systems to distribute cached information for efficient processing without overloading system resources. In an embodiment, VGENs can be implemented as software engines that can reside on a web server or another server that responds to requests for information in a networked environment. A hash table can identify whether a VGEN exists with cached information to process the request. If an available VGEN engine includes the cached information, the available VGEN is assigned to process the request; otherwise, another available VGEN can be selected to process the request, wherein the VGEN is augmented to include the cached information and the hash table is updated to reflect the VGEN statistics. VGENs can maintain persistent connections to databases, file systems, session manager daemons, real-time data sources, etc., to facilitate the processing of requests.

Although the present invention has been described relative to a specific embodiment thereof, it is not so limited. Obviously many modifications and variations of the present invention may become apparent in light of the above teachings. For example, many of the elements of the illustrated systems and methods can be combined without departing from the scope of the invention. Although the illustrated systems utilized hash tables, other methods of relating a request to a VGEN can be implemented. The illustrated VGENs were implemented in software to access cache memory areas, however the VGENs can be implemented in hardware. Although the systems and methods utilized persistent connections between the VGENs and databases, file systems, etc., some embodiments may not require or utilize persistent connections. In some embodiments, application code may not be updated as was indicated in the illustrated systems. Although the illustrated systems and methods distributed the requests among available VGENs utilizing a last-used criterion, other methods or criteria for distributing the request or otherwise performing load balancing, can be practiced. For example, total processing time can be utilized to select an available VGEN.

Many additional changes in the details, materials, steps and arrangement of parts, herein described and illustrated to explain the nature of the invention, may be made by those skilled in the art within the principle and scope of the invention. Accordingly, it will be understood that the invention is not to be limited to the embodiments disclosed herein, may be practiced otherwise than specifically described, and is to be understood from the following claims, that are to be interpreted as broadly as allowed under the law.

What is claimed is:

1. A method for processing a request, comprising,
receiving the request,
selecting a software thread based on the request,
upon determining that the selected software thread requires modification to process the request, updating the selected software thread to process the request, and,
processing the request using the selected software thread.

2. A method according to claim 1, wherein selecting the software thread based on the request further includes implementing a hash table to associate the request to at least one software thread.

3. A method according to claim 2, further including translating the request to a key for the hash table.

4. A method according to claim 2, wherein implementing a hash table to associate the request further includes,
translating a URL in the request to a key, and,
indexing the hash table by the key.

5. A method according to claim 1, wherein selecting a software thread based on the request further includes selecting a software thread based on the software thread that has been idle for the longest time.

6. A method according to claim 1, wherein determining that the selected software thread requires updating further includes, verifying the software thread includes application logic to process the request.

7. A method according to claim 1, wherein determining that the selected software thread requires updating further includes, verifying the software thread includes a most recent version of application logic to process the request.

8. A method according to claim 1, wherein updating the selected software thread to process the request further includes receiving application logic to process the request.

9. A method according to claim 1, wherein updating the selected software thread to process the request further includes establishing a persistent connection between the selected software thread and at least one database.

10. A method according to claim 1, wherein updating the selected software thread to process the request further includes establishing a persistent connection between the selected software thread and at least one file system.

11. A method according to claim 1, wherein updating the selected software thread further includes byte-compiling the data for incorporation into the software thread.

12. A method according to claim 1, wherein updating the selected software thread further comprises,
retrieving data through a persistent connection,
byte-compiling the retrieved data, and,
storing the byte-compiled data in memory local to the software thread.

13. A method according to claim 1, wherein updating the selected software thread to process the request further includes establishing a persistent connection between the selected software thread and at least one session manager daemon.

14. A method according to claim 1, wherein updating the selected software thread to process the request further includes establishing a persistent connection between the selected software thread and at least one real-time data source.

15. A method according to claim 1, wherein updating the selected software thread to process the request further includes,
comparing application logic in the selected software thread to a latest version of the application logic, and,
upon determining that the latest version of the application logic is different than the application logic in the selected software thread, incorporating the latest version of the application logic into the selected software thread.

16. A method according to claim 15, wherein determining that the latest version of the application logic is different than the application logic in the selected software thread further includes, determining that the latest version of the application software is dated more recently than the application logic in the selected software thread.

17. A method according to claim 15, wherein incorporating the latest version of the application logic into the software thread further includes, replacing the application logic in the selected software thread with the latest version of the application logic.

18. A method according to claim 1, further comprising returning the processed request to the requesting device.

19. A method according to claim 1, wherein receiving the request further includes receiving the request from a server.

20. A method according to claim 1, wherein receiving the request further includes receiving the request from a client.

21. A method according to claim 1, wherein receiving the request further includes receiving an HTTP request.

22. A method according to claim 1, wherein receiving the request further includes receiving the request from a network.

23. A method for distributing a request amongst software threads, comprising,
identifying non-processing software threads,
arranging the non-processing software threads according to use,
comparing the non-processing software threads to the request, and,
based on the comparison, selecting the a software thread to process the request.

24. A method according to claim 23, wherein selecting a software thread further comprises determining at least one of a software thread that is most infrequently used while comparing to the request, and a software thread that is most infrequently used while not comparing to the request.

25. A method according to claim 23, wherein selecting a software thread further comprises determining at least one of a software thread that has a greatest time since last use while comparing to the request, or a software thread that has greatest time since last use while not comparing to the request.

26. A method according to claim 23, wherein arranging the non-processing software threads according to use includes implementing a queue.

27. A method according to claim 26, wherein implementing a queue includes providing a first-in, first-out queue.

28. A method according to claim 23, wherein arranging the non-processing software threads according to use includes implementing a doubly linked list.

29. A method according to claim 23, wherein identifying non-processing software threads further includes, polling the software threads for activity.

30. A method according to claim 23, wherein comparing the non-processing software threads to the request further includes,
generating a key from the request,
using the key as an index to a hash table to identify software threads associated with the key, and,
identifying those associated software threads that are non-processing.

31. A system for processing a request, comprising,
a first server to receive the request, and,
a plurality of software threads to process the request, the software threads being adaptable to incorporate application logic based on the request.

32. A system according to claim 31, further comprising, at least one alternate server, at least one of the alternate servers being in communication with the first server, the alternate servers capable of receiving requests from at least one of the first server and at least one alternate server.

33. A system according to claim 32, wherein the at least one alternate servers further comprise a plurality of software threads adaptable to incorporate application logic based on the request to process the received request.

34. A system according to claim 31, further comprising a decision module to associate the request to at least one of the software threads.

35. A system according to claim 34, wherein the decision module includes a hash table.

36. A system according to claim 31, wherein the request further includes a Uniform Resource Location (URL).

37. A system according to claim 31, wherein the request is received via a network.

38. A system according to claim 31, further comprising a status module to collect statistics based on the software threads.

39. A system according to claim 38, wherein the status module further includes at least one of software thread processing status, software thread processing time, software thread application code, time of last use of software thread, and software thread persistent connections.

40. A system according to claim 38, wherein the status module further comprises a queue to order the software threads.

41. A system according to claim 38, wherein the status module further comprises a doubly linked list to order the software threads.

42. A system according to claim 31, wherein the software threads further include persistent connections to at least one database.

43. A system according to claim 31, wherein the software threads further include persistent connections to at least one real-time data source.

44. A system according to claim 31, wherein the software threads further include persistent connections to at least one session manager daemon.

45. A system according to claim 31, wherein the software threads further include persistent connections to at least one file system.

46. A system according to claim 31, further comprising local memory accessible to the software threads.
